(19) United States
(12) Patent Application Publication
(10) Pub. No.: US 2014/0315177 A1
(43) Pub. Date: Oct. 23, 2014

(54) GRADING DEVICE AND METHOD OF REMOTE TEACHING

(71) Applicant: HON HAI PRECISION INDUSTRY CO., LTD., New Taipei (TW)

(72) Inventors: MING-CHIN HO, New Taipei (TW); CHIH-YUAN HUANG, New Taipei (TW)

(73) Assignee: HON HAI PRECISION INDUSTRY CO., LTD., New Taipei (TW)

(21) Appl. No.: 14/201,953

(22) Filed: Mar. 10, 2014

(30) Foreign Application Priority Data
Apr. 19, 2013 (TW) 102114015

(51) Int. Cl. G09B 7/00

(52) U.S. Cl. CPC G09B 7/00
USPC 434/350

(57) ABSTRACT

A grading device used for grading a remotely-taught lesson includes a table generating module, a detecting module, a timing module, and a grading module. The table generating module generates a relationship table. The detecting module detects start events of the interaction segments, a start event of the lesson, stop events of the interaction segments, and a stop event of the lesson. The timing module times the start times of the lesson and the interaction segments, and the stop times of the lesson and the interaction segments, and further records the times of the interaction segments. The grading module obtains weights of the interaction segments corresponding to the times of the interaction segments from the relationship table and grades the interaction segments. A grading method is also provided.

### BACKGROUND

1. Technical Field

Embodiments of the present disclosure generally relate to remote teaching, and more particularly to a remote teaching grading device and method.

2. Description of Related Art

In remote teaching, students can review recorded lessons according to a grade of each lesson, wherein the grade represents a degree of interaction between the teacher and students of each lesson. However, the lessons are graded manually by the teacher and/or students, which is inconvenient. Furthermore, the teacher and students may forget to grade the lesson.

Therefore, there is room for improvement in the art.

### BRIEF DESCRIPTION OF THE DRAWINGS

FIG. 1 is a schematic diagram of an embodiment of an application environment for recording and grading a lesson.

FIG. 2 is a block diagram of an embodiment of function modules of a grading device.

FIG. 3 is a schematic diagram of a relationship table of the grading device of FIG. 2.

FIG. 4 is a block diagram of another embodiment of function modules of a grading device.

FIG. 5 is a flowchart of an embodiment of a grading method of a remotely-taught lesson.

FIG. 6 is a flowchart of another embodiment of a grading method of remotely-taught lesson.

### DETAILED DESCRIPTION

The embodiments are illustrated by way of example and not by way of limitation in the figures of the accompanying drawings in which like references numerals indicate similar elements. It should be noted that references to “an” or “one” embodiment in this disclosure are not necessarily to the same embodiment, and such references can mean “at least one.”

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

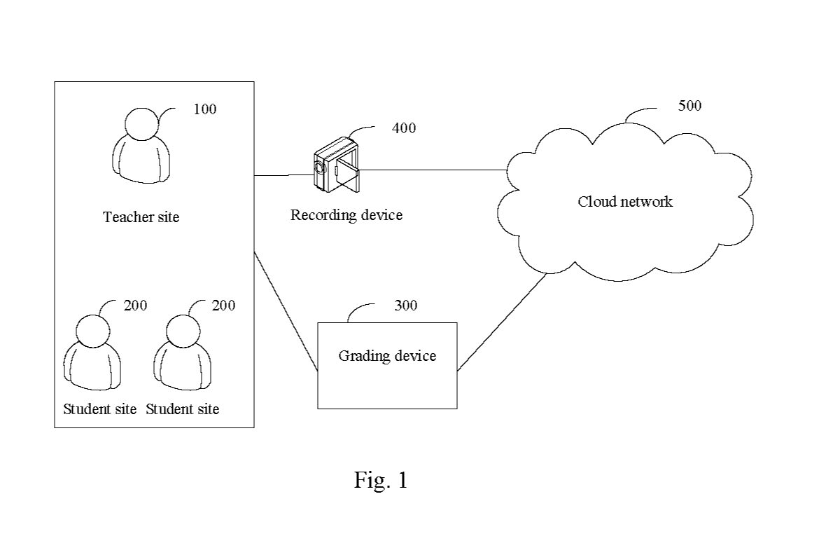

FIG. 1 is a schematic diagram of an embodiment of an application environment for recording and grading a lesson. In FIG. 1, a teacher is located at a teacher site 100, and students are located at a student site 200. The lesson is recorded by a recording device 400 and uploaded to a cloud network 500. Each lesson has a plurality of interaction segments, which occur between the teacher and the students. In the present embodiment, the recording device 400 can be a vidicon located at the teacher site 100 and the student site 200. A grading device 300 can be set at the teacher site 100 and the student site 200. The grading device 300 can connect to the cloud network 500 to access and grade the recorded lessons.

In the lesson, a start event of the lesson is defined as the moment when the teacher begins to speak, and a start event of an interaction segment is defined as the moment when the students begin to speak. In the present embodiment, the grading device 300 can segment the lessons automatically.

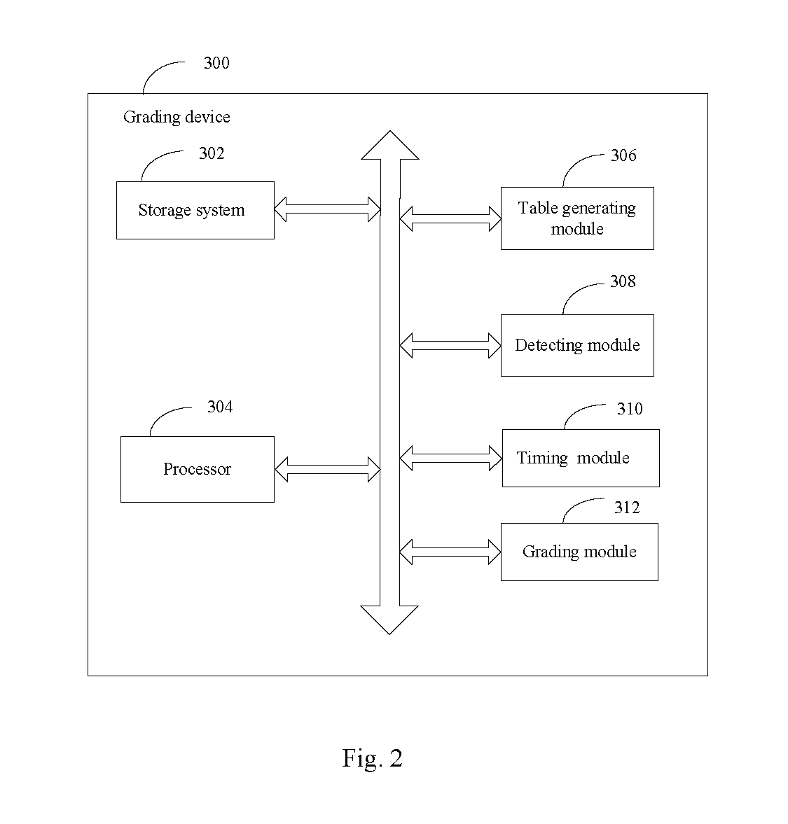

FIG. 2 is a block diagram of an embodiment of function modules of the grading device 300. In the embodiment, the grading device 300 comprises a storage system 302, a processor 304, a table generating module 306, a detecting module 308, a timing module 310, and a grading module 312.

The modules 306-312 may comprise one or more software programs in the form of computerized codes stored in the storage system 302. The computerized codes include instructions executed by the processor 304 to provide functions for the modules 306-312.

The table generating module 306 generates a relationship table, which establishes a relationship between interactions between the teacher and students in each interaction segment and weights of the interaction segments. In the present embodiment, the number of times of the interaction in each interaction segment is defined as the number of times the students speak.

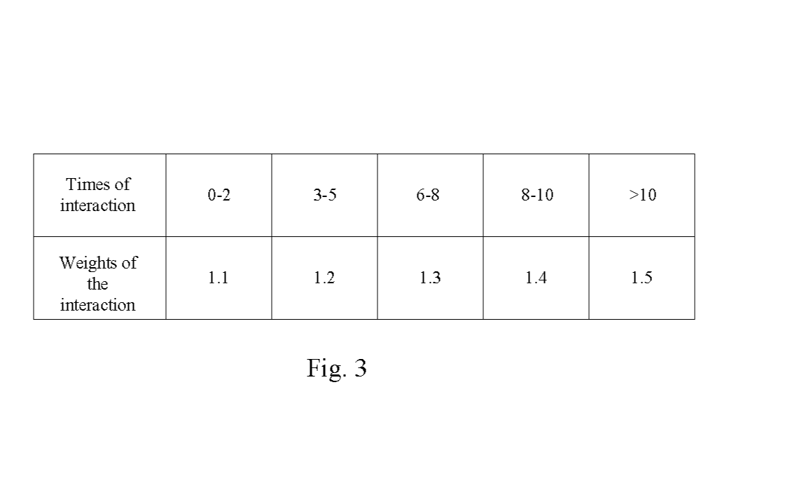

A weight of each interaction segment represents an activity degree of the interaction segment. When the weight of the interaction segment is higher, the activity degree of the interaction segment is higher. In the present embodiment, when the times of the interaction is higher, the weight of the interaction segment is higher. Referring to FIG. 3, when the times of the interaction is 0-2, the corresponding weight is 1.1. When the times of the interaction is 3-5, the corresponding weight is 1.2. When the times of the interaction is 6-8, the corresponding weight is 1.3. When the times of the interaction is 9-10, the corresponding weight is 1.4. When the times of the interaction is greater than 10, the corresponding weight is 1.5. In other embodiments, values of the weights can be preset as other values.

The detecting module 308 determines start events of the interaction segments, a start event of the lesson, stop events of the interaction segments, and a stop event of the lesson. In the present embodiment, the detecting module 304 executes its functions by detecting sound from the teacher and the students through corresponding grading devices 300. In the embodiment, the stop event of the interaction segment is determined when the students are silent longer than a first predefined time duration, and the stop event of the lesson is determined when the teacher and the students are both silent longer than a second predefined time duration. In the present embodiment, the first predefined time duration is 3 minutes, and the second predefined time duration is 5 minutes.

The timing module 310 obtains a start time of the interaction segments according to the start events of the interaction segments, a start time of the lesson according to the start event of the lesson, a stop time of the interaction segments according to the stop events of the interaction segments, and a stop time of the lesson according to the stop event of the lesson. The timing module 310 also records the times of the interaction according to the start events and stop events of the interaction segments.

The grading module 312 obtains the weights corresponding to the recorded times of the interaction from the relationship table. The grading module 312 grades the interaction segments according to the start time of the interaction segments, the stop time of the interaction segments, the start time of the lesson, the stop time of the lesson, and the obtained weights corresponding to the recorded times of the interaction. In the present embodiment, the grade of each interaction segment=(the stop time of the interaction segment−the start time of the interaction segment)*(the obtained weight of the interaction segment)/(the stop time of the lesson−the start time of the lesson). The grading module 312 also calculates a mean value of the interaction segments, and sets the mean value as a grade of the lesson.

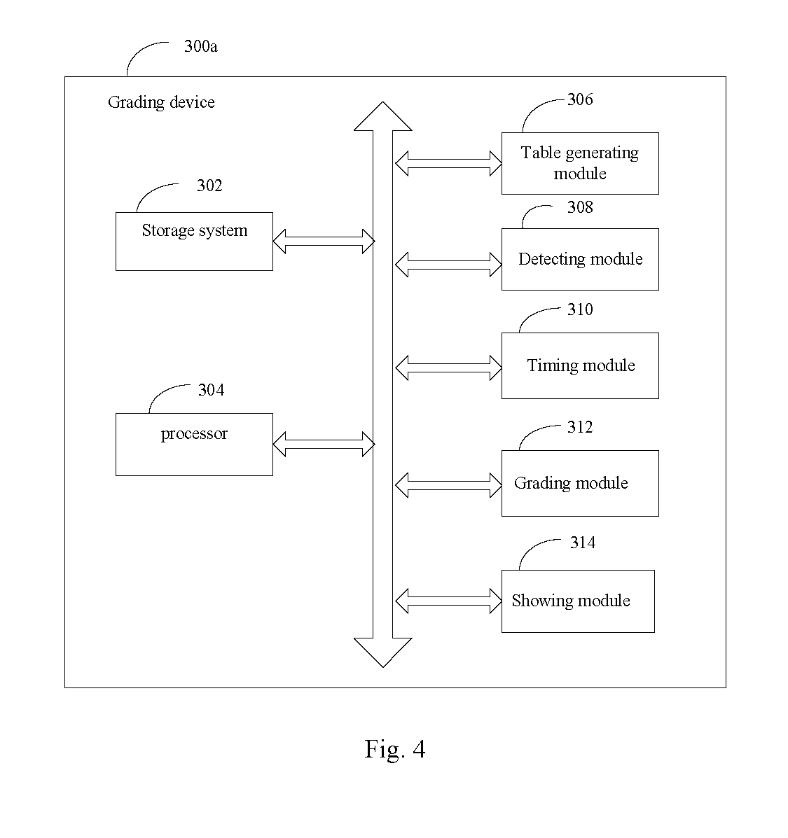

FIG. 4 is a block diagram of another embodiment of function modules of a grading device 300a. The grading device 300a further comprises a showing module 314. In the illustrated embodiment, programs are stored in the storage system 302, and are executed by the processor 304. The programs relate to the functions of the table generating module 306, the detecting module 308, the timing module 310, the grading module 312, and the showing module 314.

The showing module 314 generates and displays contracted drawings corresponding to the interaction segments, and sets display ratios of the contracted drawings according to the grades of the interaction segments. In the present embodiment, the contracted drawings having higher grader are displayed larger by scale than the contracted drawings having the lowest grade. Thus, the students can quickly know which lesson or interaction segments have the highest grade. The showing module 134 can be a touch screen to allow the students to select the lesson or the interaction segments.

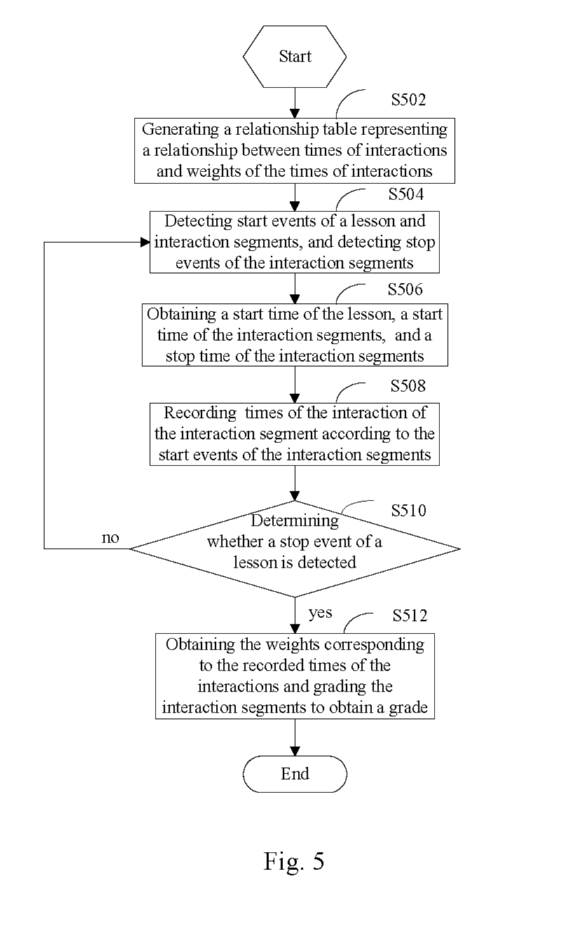

FIG. 5 is a flowchart of an embodiment of a grading method of a lesson. In the embodiment, the method is implemented in the application environment shown in FIG. 1 in the following manner and executed by the grading device 300.

In block S502, the table generating module 306 generates a relationship table, which establishes a relationship between interactions between the teacher and the students in each interaction segment and weights of the interactions. In the present embodiment, the times of the interaction in each interaction segment is defined as the number of times the students speak.

The weight of the interaction segment represents an activity degree of the interaction segment. For example, when the weight of the interaction segment is higher, the activity degree of the interaction segment is higher. In the present embodiment, when the times of the interaction is higher, the weight of the interaction segment is higher. Referring to FIG. 3, when the times of the interaction is 0-2, the corresponding weight is 1.1. When the times of the interaction is 3-5, the corresponding weight is 1.2. When the times of the interaction is 6-8, the corresponding weight is 1.3. When the times of the interaction is 9-10, the corresponding weight is 1.4. When the times of the interaction is greater than 11, the corresponding weight is 1.5. In other embodiments, values of the weights can be preset as other values.

In block S504, the detecting module 308 determines start events of the interaction segments, a start event of the lesson, stop events of the interaction segments. In the present embodiment, the start events of the interaction segments occur when the students begin to speak, the stop events of the interaction segments occur when the students are silent longer than a first predefined time duration, and the start event of the lesson occurs when the teacher begins to speak. In the present embodiment, the first predefined time duration is 3 minutes.

In block S506, the timing module 308 obtains a start time of the interaction segments according to the start events of the interaction segments, a stop time of the interaction segments according to the stop events of the interaction segments, and a start time of the lesson according to the start event of the lesson.

In block S508, the timing module 308 records the times of the interactions of each interaction segment according to the start events and stop events of the interaction segments.

In block S510, the timing module 308 determines whether a stop event of the lesson has been detected. In the present embodiment, the stop event of the lesson occurs when the teacher and the students are both silent longer than a second predefined time duration. In the embodiment, the second predefined time duration is 5 minutes.

When the stop event of the lesson has not been detected, the grading device 300 continues the step S502 to the step S508. When the stop event of the lesson has been detected, in block S512, the grading module 312 obtains the weights corresponding to the recorded times of the interaction from the relationship table, and grades the interaction segments to obtain a grade according to the start time of the interaction segments, the stop time of the interaction segments, the start time of the lesson, and the obtained weights corresponding to the recorded times of the interaction. In the present embodiment, the grade of each interaction segments=(the stop time of the interaction segment−the start time of the interaction segment)*(the obtained weight of the interaction segment)/(the stop time of the lesson−the start time of the lesson). The grading module 312 can also calculate a mean value of the grades of the interaction segments, and sets the mean value as a grade of the lesson.

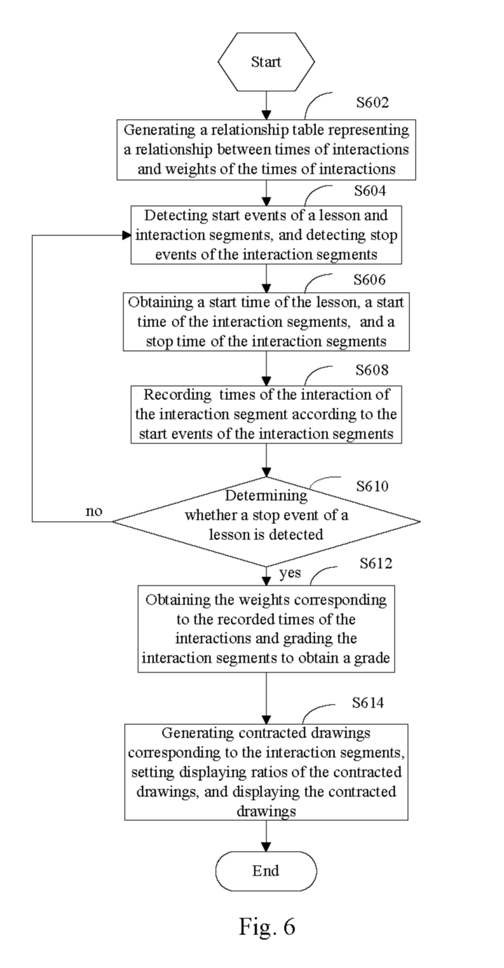

FIG. 6 is a flowchart of another embodiment of a grading method of remote teaching. In the FIG. 6, the block S602, S604, S606, S608, S610 and the block S612 are the same as the blocks S502, S504, S506, S508, S510 and the block S512 in the embodiment of FIG. 5 respectively. The grading method of the embodiment in FIG. 6 further comprises a block S614. Meanwhile, the grading method of the embodiment in FIG. 6 is executed by the grading device 300a.

In block S614, the showing module 314 generates contracted drawings corresponding to the interaction segments, and sets displaying ratios of the contracted drawings according to the grade of the interaction segments. The showing module 314 also displays the contracted drawings according to the displaying ratios corresponding to the interaction segments. In the present embodiment, the contracted drawings having higher grades are displayed larger by scale than the contracted drawings having the lowest grade. Thus, users can easily to choose a interaction segment whose grade is the highest according to the contracted drawings.

In the present embodiment, according to the presentation of the showing module 314, the students can know which lesson or interaction segments has the highest grade conveniently and quickly. The showing module 134 can be a touch screen to allow the students to select the lesson or the interaction segments.

In summary, the lesson can be easily graded and the students can select the lesson or the interaction segments conveniently according to the above-described grading method and grading device. The above-described grading method can also be applied in a remote video conference.

While various embodiments and methods have been described above, it should be understood that they have been presented by way of example only and not by way of limitation. Thus the breadth and scope of the present disclosure should not be limited by the above-described embodiments, and should be at least commensurate with the following claims and their equivalents.

What is claimed is:

1. A grading device for grading a plurality of lessons containing a plurality of interaction segments, the grading device comprising at least one processor, a storage system, and one or more programs stored in the storage system and executed by the at least one processor, the one or more programs comprising:
a table generating module generating a relationship table which establishes a relationship between times of interactions between a teacher and students in each interaction segment and weights of the interaction segments;
a detecting module detecting start events of the interaction segments, a start event of a lesson, stop events of the interaction segments, and a stop event of the lesson;
a timing module obtaining a start time of the interaction segments according to the start events of the interaction segments and a start time of the lesson according to the start event of the lesson, obtaining a stop time of the interaction segments according to the stop events of the interaction segments and a stop time of the lesson according to the stop event of the lesson, and recording the times of the interactions according to the start events of the interaction segments; and
a grading module obtaining the weights of the interaction segments corresponding to the recorded times of the interactions according to the relationship table, and grades the interaction segments to obtain a grade according to the start time of the interaction segments, the stop time of the interaction segments, the start time of the lesson, the stop time of the interaction segments, and the obtained weight corresponding to the recorded times of the interaction.

2. The grading device of claim 1, wherein the start events of the interaction segments occur when the students begin to speak, and the stop events of the interaction segments occur when the students are silent longer than a first predefined time duration.

3. The grading device of claim 1, wherein the start event of the lesson is when the teacher begins to speak, and the stop event of the lesson is when the teacher and the students are both silent longer than a second predefined time duration.

4. The grading device of claim 1, wherein the grade of each interaction segment=(the stop time of the interaction segment−the start time of the interaction segment)*(the obtained weight of the interaction)/(the stop time of the lesson−the start time of the lesson).

5. The grading device of claim 1, further comprising a showing module generating contracted drawings corresponding to the interaction segments, setting displaying ratios of the contracted drawings according to the grade of the interaction segments, and displaying the contracted drawings according to the displaying ratios corresponding to the interaction segments.

6. The grading device of claim 5, wherein the contracted drawings having higher corresponding grades are displayed larger by scale than the contracted drawings having the lowest corresponding grade.

7. The grading device of claim 1, wherein the grading module further calculates a mean value of the grades of the interaction segments of the lesson, and sets the mean value as a grade of the lesson.

8. A grading method, applied to a grading device which grades a plurality of lessons containing a plurality of interaction segments, the method comprising:
generating a relationship table establishing a relationship between times of interactions between a teacher and students in each interaction segment and weights of the times of interactions;
detecting start events of the interaction segments, a start event of the lesson, stop events of the interaction segments, and a stop event of the lesson;
obtaining a start time of the interaction segments according to the start events of the interaction segments and a start time of the lesson according to the start event of the lesson;
obtaining a stop time of the interaction segments according to the stop events of the interaction segments and a stop time of the lesson according to the stop event of the lesson;
recording the times of the interaction according to the start events of the interaction segments;
obtaining the weight corresponding to the recorded times of the interaction according to the relationship table; and
grading the interaction segments to obtain a grade according to the start time of the interaction segments, the stop time of the interaction segments, the start time of the lesson, the stop time of the interaction segments and the obtained weight corresponding to the recorded times of the interaction.

9. The method of claim 8, wherein the start events of the interaction segments occur when the students begin to speak, and the stop events of the interaction segments occur when the students are silent longer than a first predefined time duration.

10. The method of claim 8, wherein the start event of the lesson occurs when the teacher begins to speak, and the stop event of the lesson occurs when the teacher and the students are both silent longer than a second predefined time duration.

11. The method of claim 8, wherein the grade of each interaction segment=(the stop time of the interaction segment−the start time of the interaction segment)*(the obtained weight of the interaction)/(the stop time of the lesson−the start time of the lesson).

12. The method of claim 8, further comprising:
generating contracted drawings corresponding to the interaction segments, and setting displaying ratios of the contracted drawings according to the grade of the interaction segments; and
displaying the contracted drawings according to the displaying ratios corresponding to the interaction segments.

13. The method of claim 12, wherein the contracted drawings having higher corresponding grades are displayed larger by scale than the contracted drawings having the lowest corresponding grade.

14. The method of claim 8, further comprising:
calculating a mean value of the grades of the interaction segments of the lesson, and setting the mean value as a grade of the lesson.
